(19) United States
(12) Patent Application Publication
(10) Pub. No.: US 2001/0051983 A1
(43) Pub. Date: Dec. 13, 2001

(54) System and method for promoting audio content via a digital network

(76) Inventor: Eddie H. Williams, Fountain Hills, AZ (US)

Correspondence Address: Brett A. Carlson, Snell & Wilmer, LLP, One Arizona Center, 400 East Van Buren, Phoenix, AZ, 85004-2202, US

(21) Appl. No.: 09/785,613

(22) Filed: Feb. 16, 2001

Related U.S. Application Data
(60) Provisional application No. 60/183,563, filed on Feb. 18, 2000.

(51) Int. Cl. G06F 15/16

(52) U.S. Cl. 709/204

(57) ABSTRACT

According to various aspects of the present invention, a technique for promoting audio content via a digital communications network suitably includes registering an artist at a server via a digital network, receiving said audio content from the artist at the server, storing the content in a database at the server, actively and/or passively promoting the audio content via the digital network to one or more audio recipients from the server, and processing a payment form the artist at the server. An exemplary server suitable for use in promoting audio content via a digital network suitably includes a network interface, a web server or other suitable interface, and programming to execute registration, active and/or passive promotion, and payment processing functionality. Patent Application

This application claims priority of U.S. Provisional Patent Application Ser. No. 60/183,563 filed Feb. 18, 2000.

### FIELD OF THE INVENTION

The invention relates generally to systems and methods for promoting audio content. More particularly, the invention relates to systems for promoting songs, advertisements and other audio content to radio stations and the like via a digital network such as the Internet.

### BACKGROUND OF THE INVENTION

Artists, management companies, record labels and the like (collectively referred to as “artists”) frequently encounter difficulties in promoting their audio works. In particular, it is often difficult for an artist (particularly an independent artist that may not be associated with a record label) to get songs, lectures, or the like played on the radio. With reference to FIG. 1, prior art techniques for promoting audio content typically involved artists 102 either providing content directly to radio stations (see arrows 110 in FIG. 1) or providing content via direct mailers or other promoters 106. Many record industry magazines and charting companies, for example, have offered services whereby new CDs were mailed to national radio stations (and consumers) as part of the marketing and promotional materials for the magazines/charting services themselves.

Conventional promotion techniques based upon non-digital platforms typically exhibit a number of marked disadvantages. First, such techniques are typically very expensive, often on the order of tens or hundreds of thousands of dollars. Moreover, the effectiveness of direct mailings and prior art promotion schemes is frequently suspect, because there is no guarantee that the recipient actually receives the content, or that they actually review the content. Further, such services often “pigeonhole” new content into a particular category, thus effectively eliminating many potential new listeners, particularly as songs cross over from niche markets to general markets. A new song may be labelled as “rhythm and blues”, for example, even though it may have potential as a “pop” song. Similarly, “alternative” content may have potential in “rock” markets, and so on. This phenomenon is especially troublesome to small record labels or relatively unknown artists, who must compete against better-known artists and better-funded promotional campaigns to obtain airplay. Additionally, these promotion techniques required that the artist or label pay to create copies of CDs or other media that could be shipped to recipients, thus increasing the total cost of the promotion.

It is therefore desired to create a new system and technique for promoting audio content that is efficient, cost effective, and fair to both artist and recipient.

### BRIEF DESCRIPTION OF EXEMPLARY EMBODIMENTS

According to various aspects of the present invention, a technique for promoting audio content via a digital communications network suitably includes registering an artist at a server via a digital network, receiving said audio content from the artist at the server, storing the content in a database at the server, actively and/or passively promoting the audio content via the digital network to one or more audio recipients from the server, and processing a payment from the artist at the server. An exemplary server suitable for use in promoting audio content via a digital network suitably includes a network interface, a web server or other suitable interface, and programming to execute registration, active and/or passive promotion, and payment processing functionality.

By making use of the Internet or another digital network, the up-front cost of producing CDs or other media is effectively reduced or eliminated. Moreover, content may be quickly and effectively distributed across a wide range of recipients who are likely to be interested in that particular type of content.

### BRIEF DESCRIPTION OF THE DRAWING FIGURES

The above and other features and advantages of the present invention are hereinafter described in the following detailed description of illustrative embodiments to be read in conjunction with the accompanying drawing figures, wherein like reference numerals are used to identify the same or similar parts in the similar views, and:

FIG. 1 is a block diagram of an exemplary prior art promotion scheme;

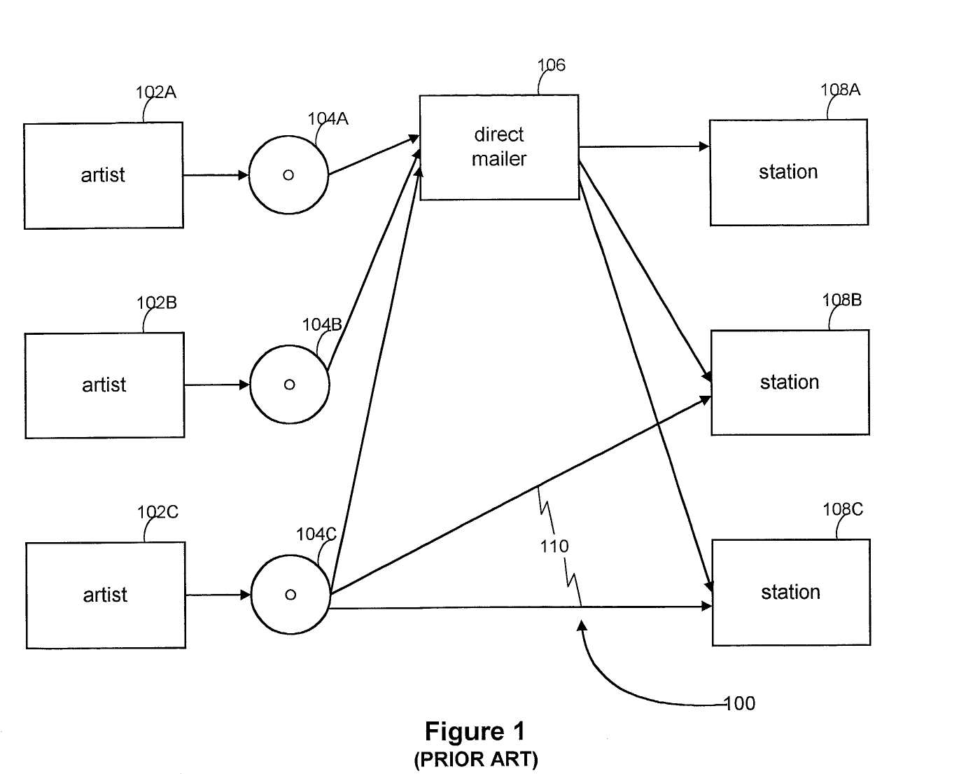

FIG. 2A is a block diagram of an exemplary promotion scheme in accordance with one aspect of the present invention;

FIG. 2B is a block diagram of an exemplary system configured to promote audio content.

FIG. 3 is a flow chart of an exemplary method of receiving and processing audio content via a digital network; and

FIG. 4 is a flow chart of an exemplary method of promoting audio content via a digital network.

### DETAILED DESCRIPTION OF EXEMPLARY EMBODIMENTS

According to various aspects of the present invention, a server is suitably placed on the internet to receive content from artists. The content may be suitably categorized according to information obtained from the artist or obtained by listening to the content. Content may be actively or passively provided to recipients via email, web interface, or any other digital technique by matching the category of the music to content preferences provided by the recipients. Artists and/or recipients may be registered and charged according to the content that they provide or receive, according to a flat fee arrangement, or any other scheme. In such a manner digital content is quickly and efficiently distributed from artists to recipients in a cost-effective manner, and in a manner that is more likely to provide recipients with the type of content that they are most interested in receiving.

To aid in the understanding of the invention, this document uses the term “artist” to refer to any source of musical, audio, or other content. The term “artist” as used herein broadly includes entertainers, performers, content providers, artists, speakers, record companies, promotion agencies, management companies, agents, and other sources of digital content. It is not necessary that the “artist” be the person who actually created or performed the content provided. Similarly, the terms “recipient”, “audio recipient”, and “station” as used herein broadly include radio stations, record companies, online music services, corporations, retail stores, nightclubs, bars, restaurants, radio or television stations, web sites or any other person or party who may be interested in receiving digital audio content.

Various aspects of the present invention may be described herein in terms of functional block components and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, PASCAL, Java, assembler, PERL, PHP, PYTHON, any database programming language or the like, with the various algorithms being implemented with any combination of data structures, objects, processes, routines or other programming elements. Similarly, the invention could be used in conjunction with any type of personal computer, network computer, workstation, minicomputer, mainframe, or other computer running any version of Windows, MacOS, BeOS, Linux, UNIX, Solaris or any other operating system. Further, it should be noted that the present invention might employ any number of conventional techniques for data transmission, signaling, data processing, network control, and the like. For example, radio frequency (RF) or other wireless techniques could be used in place of any network technique described herein. Moreover, although the invention is frequently described herein as being implemented with TCP/IP communications protocols, it will be readily understood that the invention could also be implemented using IPX, Appletalk, IP3, IP-6, NetBIOS, OSI or any number of existing or future protocols.

It should be appreciated that the particular implementations shown and described herein are illustrative of the invention and are not intended to limit the scope of the invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical content promotion system.

To simplify the description of the exemplary embodiments, the invention is frequently described as pertaining to a system of promoting songs. It will be appreciated, however, that many applications of the present invention could be formulated. For example, the present invention could be used to promote or distribute any type of audio information such as songs, advertisements, poetry, lectures, “books on tape”, recited literature, recorded live performances, advertisements, spoken word performances or the like. Moreover, the system could be used to promote and distribute other types of digital content such as audio, visual, audiovisual, multimedia, motion picture, text, object code, or any other form of digital content.

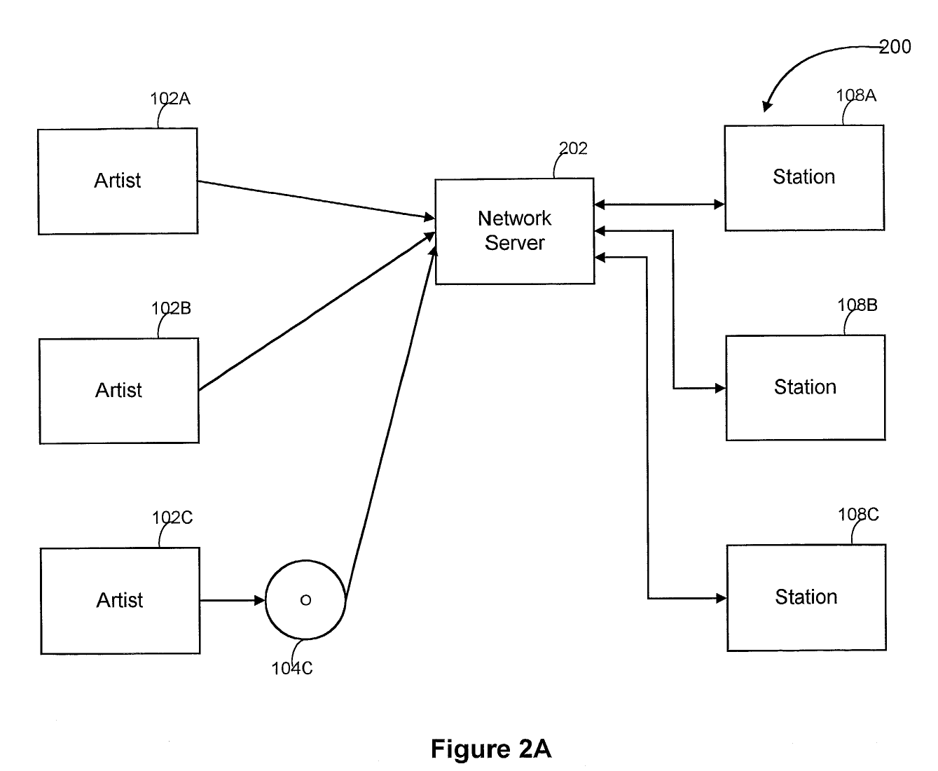

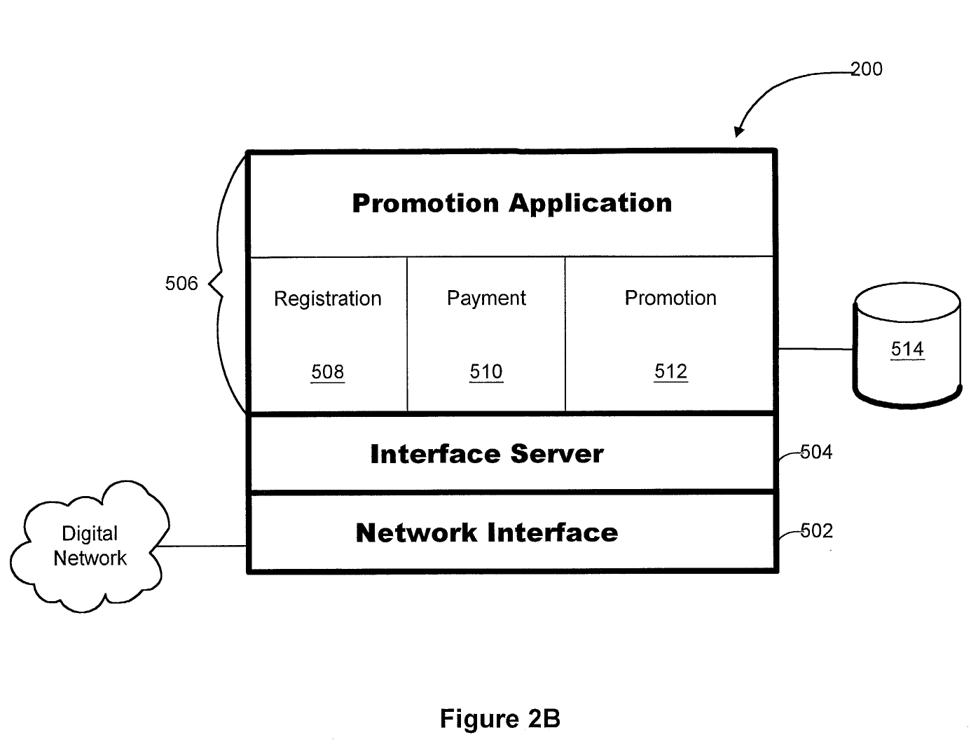

With reference to FIG. 2A, an exemplary system for promoting audio content includes a server 202 that receives content from various artists 102A, 102B, 102C and provides content to various stations 108A, 108B, and 108C. Content may be provided from artist 102 to server 202 through any technique. For example, artist 102 may create a physical medium 104 such as a compact disk, minidisc, digital audio tape (DAT), analog audio tape, vinyl record or the like that may be physically provided to server 202, as described more fully below. Alternatively, artists 102 may provide audio content directly to server 202 via a digital network (such as the Internet, a corporate network, an Ethernet network, a local or wide area network, a fiber optic network, a dial-up connection, a wireless connection, or via any other sort of network). Audio content may be provided in any format such as MP3, MP4, MIDI, AIFF, AU, WAV or any other format, and may be embedded in an email message, web page or other network transmission packet or technique. Audio content may be processed at server 202 as described below, and provided to stations 108 via the same or another digital network. In an exemplary embodiment, network server 202 is an Internet server that provides audio content to stations 108 via the Internet using conventional protocols such as the user datagram protocol (UDP) or the transmission control protocol (TCP), although of course any networking techniques could be used in various alternate embodiments.

FIG. 2B is a block diagram of an exemplary embodiment of server 202. With reference now to FIG. 2B, an exemplary system 202 for promoting audio content suitably includes an interface 502 to the Internet or another appropriate digital network, an interface server 504 such as a web server application, and a promotion application 506. Server 202 may be implemented on any computer or workstation such as a personal computer or workstation running any version of the Windows operating system available from the Microsoft Corporation of Redmond, Washington. Alternatively, server 202 may run any version of UNIX, LINUX, MacOS, BeOS, Solaris or any other operating system. System 202 will typically include conventional microprocessor, memory and input/output functionality commonly found on such computers. In various embodiments the modules shown in FIG. 2B are implemented on separate computing systems which are configured to operate as a cluster or single server system.

Network interface 502 may include any suitable network interface card (NIC), cable modem, router or other interface to the digital network. Interface application 504 is any application capable of handling input and output between system 202, artists 102 and/or recipients 108 such as a web server, email server, file transfer protocol (FTP) server, or the like. In an exemplary embodiment, interface application 504 is a web server such as the Apache web server available from the Apache Software Foundation, or any other conventional web server.

Promotion application 506 may be stored in digital memory on server 202, in a hard drive, or in any other digital storage medium. Various embodiments of promotion application 504 suitably include a registration module 508, a payment module 510 and a promotion module 512. The particular modules described herein are solely to aid in understanding the invention; it should be appreciated that functions and implementations of each module will vary widely from embodiment to embodiment, and in a practical embodiment the particular functionalities of the various modules may be intertwined, handled or divided in different ways.

An exemplary registration module 508 suitably includes programming instructions (for example in PHP, Java or any other language) for handling registration of artists 102 and recipients 108. Such a module may include routines for obtaining and storing such information in a database associated with server 202. Registration information may be obtained in any manner; users may complete an online form, for example, or may enter information as otherwise prompted by registration module 508. Additional detail about the registration process is described below.

An exemplary payment module 510 suitably handles tasks associated with processing payment for services performed by server 202. Payment module 510 suitably communicates with registration module 508 or a database of registration information to process credit card payments, bank draft transfers or other forms of payment as appropriate. Payment may be handled at the time of registration, at the time content is provide by an artist 102 or received by a recipient 108, according to any regular interval (e.g. weekly, monthly, annually) or according to any other scheme.

An exemplary promotion module 512 suitably administers active and/or passive promotion of materials provided by artist 102 to recipients 108. Various embodiments of module 512 suitably include programming instructions to execute receipt of content from artists 102, to query and receive instructions from artist 102 regarding the type of promotion services requested (as well as a list of recipients to be targeted, in some embodiments), to store the content in a database 514 as appropriate, and to execute the desired promotion services. Database 514 is any hierarchial, relational, object-oriented or other database that is capable of storing digital audio content. In various embodiments, “metadata” or other information about the content is also stored in database 514 so that the content may be searched according to content type, audio format, music type, or the like. Exemplary processes for active/passive promotion and other aspects of the promotion process are described below.

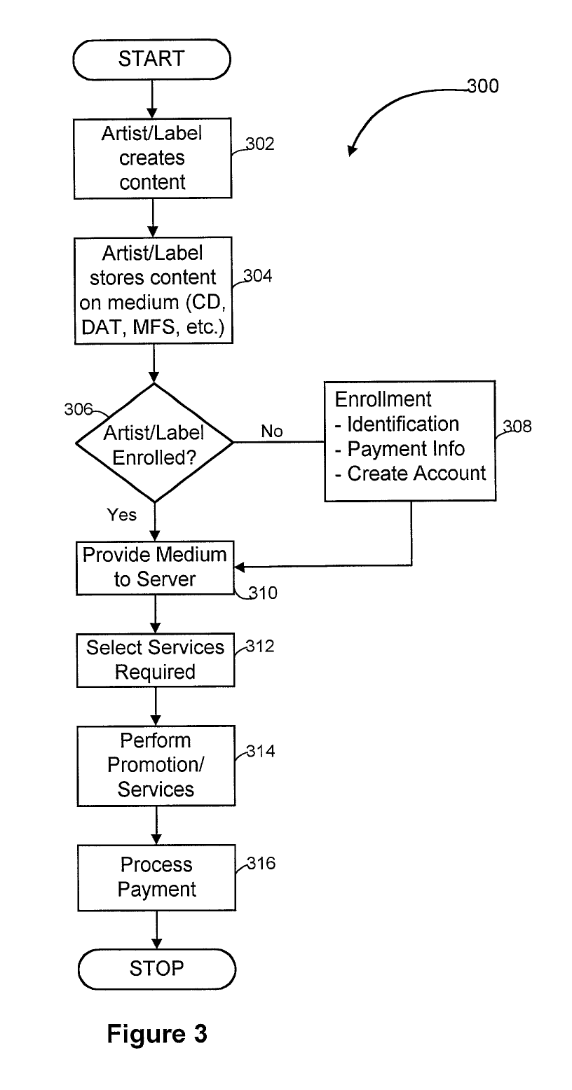

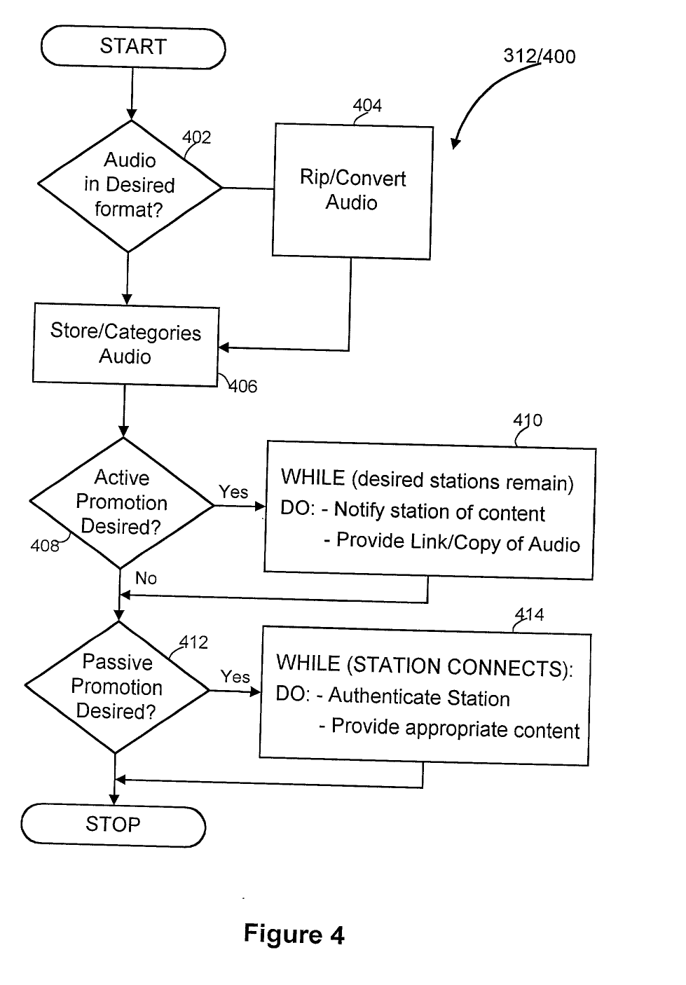

FIGS. 3 and 4 describe exemplary techniques for receiving, processing and promoting audio content. It should be appreciated that the invention may be practiced in any number of ways in addition to the techniques disclosed in the Figures. In particular, the various processing steps disclosed may be processed in any order. For example, content received on a physical media 104 may be converted or “ripped” at any time during processes 300/310/314. Similarly, payment may be processed at any time. The ambit of the present invention includes all of the various permutations, orders and combinations of executing the various steps described herein.

With reference to FIG. 3, an exemplary method 300 for receiving audio content from an artist 102 suitably includes one or more artists 102 generating audio content (step 302) and storing the content on a digital or analog medium (step 304) such as a hard drive, random access memory (RAM), minidisc, digital audio tape, floppy disk, optical disk or any other digital storage medium. The content is suitably provided to server 202 (FIG. 2), either directly via a computer network via email, web page, or the like (if the medium is an MP3 or other digital audio file) or via physical shipping, carrying or otherwise providing the storage medium to be read by server 202 (if the medium is a compact disk, DAT, or other physical medium). The content may be stored on a hard drive, optical drive, memory or other storage device on server 302 at this point, or the content may be maintained in the shipping medium, as appropriate. If the artist is previously enrolled in the promotion service (step 306), the content may be processed as desired (steps 310, 312, and 314) and as described more fully below. If the artist is not previously enrolled in the promotion service, an optional enrollment process (step 308) executes at server 202 to obtain identifying information about the artist. Identifying information may include name, address, email address, or other contact information as well as optional demographic information and information about the content or type of content typically generated by the artist, as appropriate. In various embodiments, payment information (such as a credit card number) may also be requested during enrollment. When sufficient and appropriate information about artist 102 is obtained, server 202 may create an account for artist 102 that may be stored in an optional database at server 202, for example. The account may include a userid/password combination, or another form of identifying credential (such as a public/private key encryption pair, a digital signature, cookie, or any other sort of credential) so that artist 102 may bypass the enrollment process 308 in subsequent connections to server 202.

Processing of the content suitably includes placing the content in a suitable format and providing the content to the server as appropriate (step 310), selecting services required (step 312), and performing the services requested (step 314) as described more fully below. In alternate embodiments, step 310 may be modified or eliminated as appropriate, as the content may already be provided in a suitable format. Content may be stored in a database associated with server 202 in association with information about the content as described more fully below. Artists 102 may be suitably prompted to select active or passive promotion, particular recipients or classes of recipients, or the like (step 312). Additionally, artist 102 may be asked to provide information about the content, such as a description of a song, type of music, instrumention, or the like. Such selections and information may be stored and/or processed by the server as described below in conjunction with FIG. 4.

Artists 102 may be billed, invoiced or otherwise charged for promotional services as appropriate (step 316). For example, artists could be charged a monthly or annual fee for unlimited use of the service; artists could be charged a flat fee to promote each song or other article of content; artists could be charged differing rates for active or passive promotion; artists could be charged for each target or recipient of promoted materials; or any other scheme could be formulated. In other embodiments, artists may not be charged for some or all services, or certain services may be provided free of charge to promote service 300.

Various embodiments also register and process recipients 108 as appropriate. Recipients 108 may contact server 202 via email, HTML, network connection or any other digital technique, or they may request enrollment via telephone, in person or any other means. In various embodiments, the recipient enrollment process suitably includes obtaining contact information (name, address, email address, phone number and/or the like), along with content preferences for the type of content that the recipient would like to receive. Certain types of recipients may want to receive pop and R&B content, for example, while others may select “rock”, “alternative” or the like. Of course a virtually infinite number of categorizations could be formulated in the various embodiments. Recipients 108 may also provide payment information at registration in certain embodiments so that they can be charged for receiving the content as appropriate. Recipients 108 may be charged according to any scheme such as a weekly, annual or monthly flat fee, or according to the number of bytes/minutes/items of content received, or otherwise. In other embodiments, recipients 108 may be provided with content free-of-charge, or recipients may be encouraged to join the system with free memberships, promotions, or the like.

With reference now to FIG. 4, an exemplary technique 314 for processing and promoting the audio content suitably includes transforming the content to a desired format (such as MP3 or another digital format), if required (step 402) and actively and/or passively promoting the content. As briefly described above, converting the audio content may involve transferring information from a DAT, compact disk or other physical media. Such a transformation may be performed, for example, by a conventional “ripping” program such as the AudioCatalyst program available from the Xing corporation, or by any other program. Audio content may be converted to any desired format such as MP3, MP4, MPEG, WAV, AU, AIFF, MIDI or any other format and stored on a harddrive, optical drive, writable compact disk, memory, network file server, or other storage device as appropriate (step 406). In various embodiments, audio files may be categorized according to content type, music type, artist, style, record label, instrumentation, genre or any other type of categorization as appropriate. Such categorization information may be obtained from the artist or may be entered by an administrator after reviewing the content, or from any other source. Categorization information may be stored in a database with server 202 for later search and retrieval.

Promotion of the audio content may be active, passive, and/or a combination of active and passive techniques. Active promotion (steps 408 and 410) may involve actively providing the audio content, a description of the audio content, and/or a link to the audio content from server 202 to one or more recipients 108, as appropriate. The particularly content promoted to any recipient 108 may be suitably tailored to the particular recipient by comparing the categorization information stored with the content to the content preferences provided by recipient 108. Content may be provided via email, via a specialized application, through conventional TCP/IP or web page techniques, though conventional “push” techniques, or through any other means.

Passive promotion may involve categorizing or otherwise determining audio content that a particular recipient 108 may be interested in, and then providing a list of such content when the recipient “logs in” or otherwise contacts server 202. In the passive promotion model, recipients may be assigned accounts with userid/password pairs or other digital credentials to maintain security (see above). When a representative of a particular recipient 108 presents the appropriate credentials, a suitable list of audio content may be provided and the recipient 108 may select desired content to review, download or otherwise process. Alternatively, a search engine may be provided that allows the recipient 108 to search for a particular artist, song, record label or style of music. Recipients 108 may also be charged for access to server 202, as appropriate, and as described above. Of course, other types of promotion schemes could be formulated. A combination of active and passive promotion techniques, for example, could involve sending a brief description of a particular song or other bit of content to a station 108 and allowing a representative of station 108 to contact server 202 for more information, to sample the content, or to actually obtain the audio content.

In various embodiments of active and/or passive promotion, recipients 108 may obtain the actual content produced by artist 102 via server 202, thus reducing the need for artist 102 to create, distribute and promote physical media embodying the audio content. In contrast, recipients 108 may directly download content from server 202 in, for example, MP3 format that can be reviewed, duplicated and played on-air as appropriate. It will therefore be understood that the use of server 202 as a distribution and promotion channel effectively reduces the costs and time required in the prior art to create compact disks or other media, to distribute the media, and to effectively promote the audio content.

The corresponding structures, materials, acts and equivalents of all elements in the claims below are intended to include any structure, material or acts for performing the functions in combination with other claimed elements as specifically claimed. The scope of the invention should be determined by the appended claims and their legal equivalents, rather than by the examples given above. No element describe herein shall be interpreted as essential for the practice of the invention unless expressly described herein as “necessary” or “required”.

What is claimed is:

1. A method of promoting audio content, the method comprising the steps of:
registering an artist at a server via a digital network;
receiving said audio content from said artist at said server via said digital network;
storing said content at said server;
promoting said audio content via said digital network to a plurality of audio recipients from said server; and
processing a payment from said artist at said server.

2. The method of claim 1 wherein said registering step comprises obtaining financial information from said artist to be used by said processing step.

3. The method of claim 2 wherein said registering step further comprises providing a digital credential configured to identify said artist.

4. The method of claim 1 wherein said storing step comprises storing said information with categorization information about said content.

5. The method of claim 2 wherein said promoting step comprises active promotion.

6. The method of claim 2 wherein said promoting step comprises passive promotion.

7. The method of claim 4 wherein said promoting step further comprises passive promotion.

8. The method of claim 7 further comprising the step of obtaining content preferences from said audio recipients at said server.

9. The method of claim 8 wherein said promoting step comprises:
receiving a request for content from one of said audio recipients at said server;
providing content to said one of said audio recipients in response to said request, wherein said content is selected as a function of said content preferences to said content consumers.

10. The method of claim 8 wherein said promoting step comprises actively distributing said content to said content consumer if said categorization information is compatible with said content preferences.

11. A system configured to implement the method of claim 1.

12. A computer readable medium having instructions stored thereon, wherein said instructions are configured to execute the method of claim 1.

13. A system configured to implement the method of claim 9.

14. A computer readable medium having instructions stored thereon, wherein said instructions are configured to execute the method of claim 9.

15. A system configured to implement the method of claim 10.

16. A computer readable medium having instructions stored thereon, wherein said instructions are configured to execute the method of claim 10.

17. A system for promoting digital audio content, the system comprising:
a network interface coupled to a digital network;
an interface server application configured to provide input/output functionality via said network interface; and
an application server comprising:
a registration module in communication with said interface server application configured to register artists and recipients;
a payment processing module in communication with said registration module configured to process payments made by said artists over said digital network; and
a promotion module configured to promote digital content via said interface server application, to store said digital content in a database, and to promote said audio content to said recipients.

18. The system of claim 17 wherein said database is configured to store said digital content in conjunction with categorization information about said content.

19. The system of claim 18 wherein said promotion module is configured receive requests for content from said recipients via said interface server application and to provide said content to said recipients in response to said requests, wherein said content is selected as a function of content preferences obtained from said recipients.

20. The method of claim 8 wherein said promoting step comprises actively distributing said content to said recipients if said categorization information is compatible with content preferences obtained from said recipients.
